(19) United States
(12) Patent Application Publication
(10) Pub. No.: US 2009/0055775 A1
(43) Pub. Date: Feb. 26, 2009

(54) DISPLAY APPARATUS AND STORAGE MEDIUM STORING DISPLAY PROGRAM

(75) Inventor: Hiroaki Suzuki, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/235,115

(22) Filed: Sep. 22, 2008

Related U.S. Application Data
(63) Continuation-in-part of application No. PCT/JP2007/050673, filed on Jan. 18, 2007.

(30) Foreign Application Priority Data
Mar. 20, 2006 (JP) 2006076476

(51) Int. Cl. G06F 3/048

(52) U.S. Cl. 715/810

(57) ABSTRACT

A display apparatus includes a display section, a first storage section, a display controlling section, a second storage section, a storage controlling section, an order determining section, and a list display controlling section. The display section displays a content including at least one of texts and images. The first storage section stores a plurality of content files. The display controlling section displays, on the display section, the content based on the plurality of content files. The second storage section stores, for each content file, operation information indicating a predetermined operation performed by a user during display of each content file. The storage controlling section stores the operation information in the second storage section. The order determining section determines the order of the plurality of content files according to the operation information stored in the second storage section. The list display controlling section displays an image of a list on the display section, the list including the plurality of content files arrayed according to the order determined by the order determining section.

### CROSS REFERENCE TO RELATED APPLICATION

This application claims priority from Japanese Patent Application No. 2006-076476 filed Mar. 20, 2006. This application is also a continuation-in-part of International Application No. PCT/JP2007/050673 filed Jan. 18, 2007 in Japan Patent Office as a Receiving Office. The contents of both applications are incorporated herein by reference in its entirety.

### TECHNICAL FIELD

The present invention relates to a display apparatus and a storage medium storing a display program.

### BACKGROUND

A conventional display apparatus such as an electronic book retrieves a content file from a plurality of content files stored in a storage section and displays a content stored in the content file. Such a display apparatus has a function to display a list of content files stored in the storage section so that a user can be informed what kinds of content files are stored in the storage section. When such a list is displayed, the content files are preferably displayed according to the importance for the user.

In addition, there is provided another electronic book that displays an index of document blocks in descending order in terms of the cumulative display time for each document block (Refer to Japanese Patent Application No. 2002-269091, for example).

Such a technique of displaying an index based on the cumulative display time may be applied to the above mentioned function of displaying a list of content files. That is, a list of content files can be displayed in descending order in terms of the cumulative display time.

However, sorting the list of content files based simply on the cumulative display time cannot achieve a display of the list in the order of importance for the user. For example, when a user forgets to turn off the power of a display apparatus and has left his seat while the apparatus is displaying a content file, the cumulative display time for the content file is to be counted. Therefore, only the cumulative display time cannot distinguish content files attractive to the user from other content files that are not attractive to the user.

An object of the present invention is therefore to provide a display apparatus and a storage medium storing a display program that can display a list of content files in such a manner that the content files are arranged in the order of importance for a user.

### SUMMARY

In order to achieve the above and other objects, the present invention provides a display apparatus. The display apparatus includes: a display section that displays a content including at least one of texts and images; a first storage section that stores a plurality of content files; a display controlling section that displays, on the display section, the content based on the plurality of content files; a second storage section that stores, for each content file, operation information indicating a predetermined operation performed by a user during display of each content file; a storage controlling section that stores the operation information for each content file in the second storage section; an order determining section that determines the order of the plurality of content files according to the operation information stored in the second storage section for each content file; and a list display controlling section that displays an image of a list on the display section, the list including the plurality of content files arrayed according to the order determined by the order determining section.

According to another aspect of the invention, the present invention provides a storage medium storing a display program that has a set of program instructions executable on a computer serving as a display apparatus. The display apparatus includes a display section that displays a content including at least one of texts and images; a first storage section that stores a plurality of content files; a display controlling section that displays, on the display section, the content based on the plurality of content files; and a second storage section that stores, from each content file, operation information indicating a predetermined operation performed by a user during display of each content file. The set of program instructions includes storing the operation information in the second storage section; determining the order of the plurality of content files according to the operation information; and displaying an image of a list on the display section, the list including the plurality of content files arrayed according to the determined order.

### BRIEF DESCRIPTION OF THE DRAWINGS

The particular features and advantages of the invention as well as other objects will become apparent from the following description taken in connection with the accompanying drawings, in which:

FIG. 1 is a front view of a display apparatus according to an embodiment of the present invention;

FIG. 2 is a block diagram showing a configuration of the display apparatus according to the embodiment of the present invention;

FIG. 3 is a model of a content file used in the display apparatus according to the embodiment of the present invention;

FIG. 4 is a diagram of a display order determination table used in the display apparatus according to the embodiment of the present invention;

FIG. 5 is a flowchart of a main process executed by the display apparatus according to the embodiment of the present invention;

FIG. 6 is a flowchart of a list display process executed in the main process shown in FIG. 5;

FIG. 7 is a display-order list generated in S11 of FIG. 6;

FIG. 8 is a flowchart of a priority calculation process executed in the list display process shown in FIG. 6;

FIG. 9 is a flowchart of a sorting process based on “page-turning count” executed in the priority calculation process shown in FIG. 8;

FIGS. 10(a) to 10(d) are explanatory diagrams for interchanging names of the 10th content file and the 9th content file in S106 of FIG. 9;

FIG. 11 is a flowchart of a sorting process based on “page-turning count/page count” executed in the priority calculation process shown in FIG. 8;

FIG. 12 is a flowchart of a sorting process based on “time-of-day page-turning count” executed in the priority calculation process shown in FIG. 8;

FIG. 13 is a flowchart of a sorting process based on “relevant degree” executed in the priority calculation process shown in FIG. 8;

FIG. 14 is a relevant degree matrix created in S400 of FIG. 13;

FIG. 15 is a display-order list sorted in descending order in terms of “page-turning count” as a result of the sorting process based on the “page-turning count” shown in FIG. 9;

FIG. 16 is a display-order list obtained as a result of the sorting process according to the “relevant degree” shown in FIG. 13, based on the display-order list of FIG. 15;

FIG. 17 is a view showing a list of content files when the “page-turning count” is set as a priority criterion but the “relevant degree” is not set as the priority criterion in the display apparatus according to the present embodiment;

FIG. 18 is a view showing a list of content files when the “page-turning count/page count” is set as the priority criterion but the “relevant degree” is not set as the priority criterion in the display apparatus according to the present embodiment;

FIG. 19 is a view showing a list of content files when the “time-of-day page-turning count” is set as the priority criterion but the “relevant degree” is not set as the priority criterion in the display apparatus according to the present embodiment;

FIG. 20 is a view showing a list of content files when both the “page-turning count” and “relevant degree” are set as the priority criteria in the display apparatus according to the present embodiment;

FIG. 21 is a flowchart of key input waiting process executed in the main process shown in FIG. 5;

FIG. 22 is a view showing a priority criterion selection screen in the display apparatus according to the present embodiment;

FIG. 23 is a flowchart of a cross key up/down operation process executed in the key input waiting process shown in FIG. 21;

FIG. 24 is a flowchart of a determination button operation process executed in the key input waiting process shown in FIG. 21;

FIG. 25 is a flowchart of a page-turning execution process executed in the key input waiting process shown in FIG. 21;

FIG. 26 is a display order determination table used when the display order is determined based on evaluation values in the display apparatus according to an embodiment of the present invention;

FIG. 27 is a view showing a state where thumbnails of respective contents are displayed on the display apparatus according to an embodiment of the present invention;

FIG. 28 is a view showing a modification of the number indicating the display order of content files in the display apparatus according to the embodiment of the present invention;

FIG. 29 is a view showing a modification of the display order determination table used in the display apparatus according to the embodiment of the present invention; and

FIG. 30 is a view showing a state where content files that have never been displayed are displayed higher on the list in the display apparatus according to an embodiment of the present invention.

### DETAILED DESCRIPTION

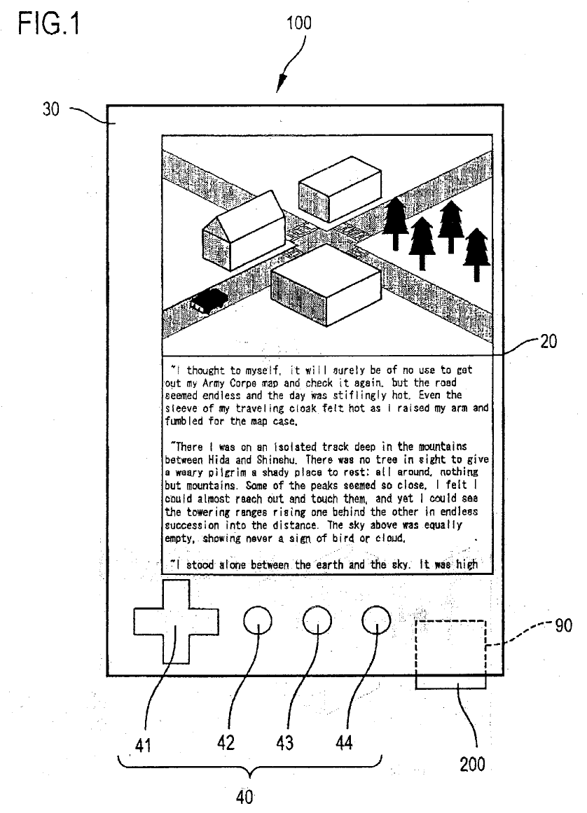

Hereinafter, an embodiment of the present invention will be described with reference to the accompanying drawings. FIG. 1 is a front view of a display apparatus 100 for displaying a content including texts and images according to an embodiment of the present invention.

As shown in FIG. 1, the display apparatus 100 includes a display panel 20 capable of displaying texts or images, a frame member 30, an operation section 40, and a reading section 90. In the following description, a surface of the display apparatus 100 on which the display panel 20 is disposed is referred to as “upper surface” and another surface opposite to the upper surface is referred to as “lower surface”.

The display panel 20 is an electrophoretic display medium having a configuration that display liquid with colored charged particles dispersed therein is sealed between two glass substrates. A surface of the two glass substrates constituting the display panel 20 is exposed from the frame member 30 at the upper surface side, and serves as a display surface. When a voltage is applied to electrodes (not shown) provided respectively on the two glass substrates based on a content file, the charged particles in the display liquid migrate. An image can be displayed based on the charged particles migrated to the display surface side. Since such an electrophoretic display medium is disclosed in Japanese Patent Publication No. 2004-013119, the detailed description thereof is omitted here.

The frame member 30 surrounds the display panel 20 and has the operation section 40 on the upper surface. The operation section 40 is arranged below the display panel 20. The operation section 40 includes a cross key 41, a determination button 42, a list display button 43, and a selection screen display button 44. The cross key 41, determination button 42, list display button 43, and selection screen display button 44 are arranged at predetermined intervals in the order mentioned from the left.

The cross key 41 is a key for selecting a content file to be displayed in a key input operation waiting process to be described later.

The determination button 42 is a key for determining a content file to be displayed in the key input operation waiting process.

The list display button 43 is a key for displaying a list display screen to be described later in the key input operation waiting process.

The selection screen display button 44 is a key for displaying a priority criterion selection screen to be described later in the key input operation waiting process.

The reading section 90 is arranged on the right side of the lower surface of the frame member 30 when viewed from the front. The reading section 90 retrieves a content file from a storage medium 200 storing content files and a display order determination table to be described later. The storage medium 200 is detachably mounted in the reading section 90. A user mounts the storage medium 200 in the reading section 90 for displaying a content file stored in the storage medium 200 when necessary.

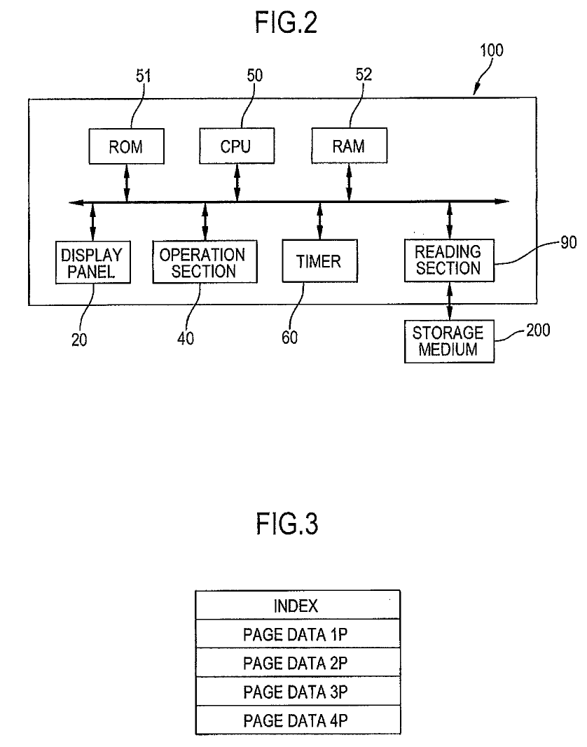

FIG. 2 is a block diagram showing a configuration of the display apparatus 100. As shown in FIG. 2, the display apparatus 100 includes a CPU 50, a ROM 51, a RAM 52, the reading section 90, the operation section 40, a timer 60, and the display panel 20.

The CPU 50 executes processes including a main process to be described later. The ROM 51 stores various programs such as a display program that instructs the CPU 50 to execute the main process.

The RAM 52 is a nonvolatile RAM and has a work area that the CPU 50 uses for executing the above processes and a storage area for storing predetermined information.

The storage medium 200 stores a plurality of content files 1 to 10 and a display order determination table the details of which will be described later.

A configuration of the content file used in the display apparatus 100 will be described here. FIG. 3 is a model of the content file stored in the storage medium 200. The content file according to the present embodiment is made up of an index and a page data group (page data 1P to 4P).

The index has information including a name of the content file, a number of pages, and link information navigating to respective page data.

A plurality of page data (page unit data) constitutes the page data group. For example, the page data group of the content file shown in FIG. 3 includes page data 1P to 4P.

The page data includes texts and/or images corresponding to one page to be displayed on the display panel 20. The page data may have a bit-map format that includes tone and color information for each pixel, or a text format that includes only text code information, or may be a combination of the above two. That is, here, data to be finally outputted as texts or images corresponding to one page display on the display panel 20 is referred to as the page data.

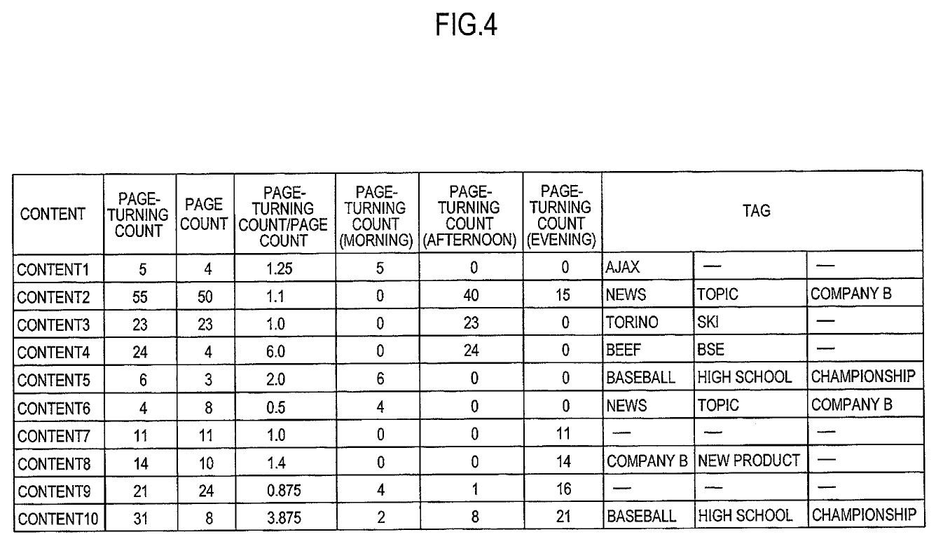

A configuration of the display order determination table stored in the storage medium 200 will be described. FIG. 4 is a view showing the display order determination table.

As shown in FIG. 4, the following information is stored in the storage medium 200 for respective contents 1 to 10: “page-turning count”, “page count”, “page-turning count/page count”, “page-turning count (morning)”, “page-turning count (afternoon)”, “page-turning count (evening)” and “tag”.

The “page-turning count” is information representing a cumulative number of times page-turning operations are performed during display of each content file.

The “page count” is information representing a total number of pages contained in each content file, i.e., a number of page data contained in each content file.

The “page-turning count/page count” is information representing a value obtained by dividing the “page-turning count” by the “page count”.

The “page-turning count (morning)” is information representing a cumulative number of times the page-turning operations are performed during display of each content file in the morning. Specifically, a time category from 6:00 to 12:00 of a day is designated as the morning.

The “page-turning count (afternoon)” is information representing a cumulative number of times the page-turning operations are performed during display of each content file in the afternoon. Specifically, a time category from 12:00 to 18:00 of a day is designated as the afternoon.

The “page-turning count (evening)” is information representing a cumulative number of times the page-turning operations are performed during display of each content file in the evening. Specifically, a time category from 18:00 to 6:00 of a day is designated as the evening.

The “tag” is information of a keyword assigned in advance to each content file. One or more keywords strongly associated with each content file are preliminarily assigned to each content file. In contrast, there may exist a content file that has no keyword assigned thereto.

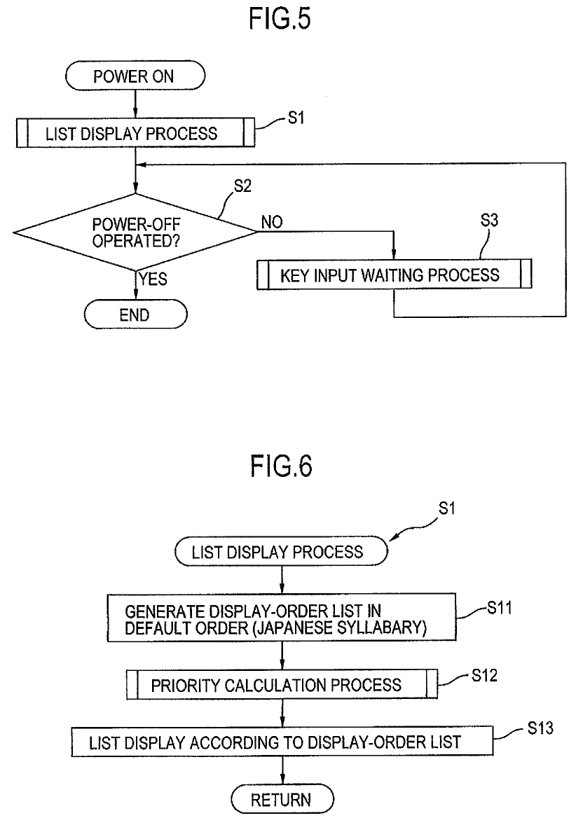

Operations of the display apparatus 100 will be described in detail with reference to the flowcharts. FIG. 5 is a flowchart of the main process performed by the CPU 50 of the display apparatus 100.

When a user depress a power button (not shown) to turn on the power of the display apparatus 100, the CPU 50 starts the main process shown in FIG. 5 based on the display program stored in the ROM 51.

Upon starting the main process, the CPU 50 first executes a list display process in step 1 (hereinafter step is abbreviated as “S”). In the list display process of S1, the CPU 50 displays a list display screen which is an image of a list of the content files 1 to 10 stored in the storage medium 200 connected to the reading section 90.

Then, the CPU 50 determines whether the power button has been depressed again (S2). When the power button has not been depressed (S2: NO), the CPU 50 executes a key input waiting process (S3) and returns to S2. When the power button has been depressed (S2: YES), the CPU 50 ends the main process and turns off the power of the display apparatus 100.

Next, details of the list display process of S1 will be described with reference to FIG. 6.

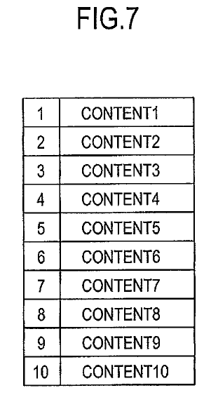

As shown in FIG. 6, upon starting the list display process (S1), the CPU 50 first generates, in the RAM 52, a display-order list in which the content files are arranged in a default order (in the order of the Japanese syllabary) (S11). The display-order list generated at this time is shown in FIG. 7. Since the display-order list is generated based on the order of the Japanese syllabary, the content files 1 to 10 on the list are arranged from the top in the order of “content 1” which is the name of the content file 1, “content 2” which is the name of the content file 2, “content 3” which is the name of the content file 3, “content 4” which is the name of the content file 4, “content 5” which is the name of the content file 5, “content 6” which is the name of the content file 6, “content 7” which is the name of the content file 7, “content 8” which is the name of the content file 8, “content 9” which is the name of the content file 9, and “content 10” which is the name of the content file 10.

Then, the CPU 50 executes a priority calculation process to sort the display-order list generated in S11 according to a predetermined priority criterion (S12). The detail of the priority calculation process of S12 will be described later.

Then, the CPU 50 displays a list of the contents 1 to 10 on the display panel 20 based on the display-order list sorted according to the result of the priority calculation process of S12 (S13) and ends the list display process (S1).

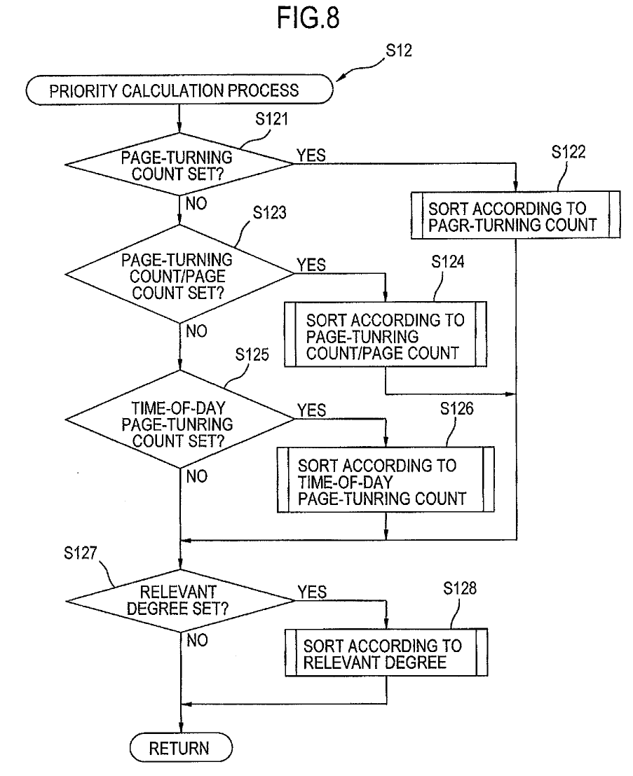

The detail of the priority calculation process of S12 will be described. In the priority calculation process (S12), the CPU 50 sorts the display-order list generated in S11 based on a predetermined priority criterion. FIG. 8 shows a flowchart of the priority calculation process (S12).

When Starting the Priority Calculation Process (S12), the CPU 50 determines whether the “page-turning count” is set as a priority criterion (S121). The priority criterion is previously set on a priority criterion selection screen, as will be described later. When the “page-turning count” is set as the priority criterion (S121: YES), the CPU 50 executes a sorting process based on the “page-turning count” (S122) and then proceeds to S127 which will be described later. The detail of the sorting process based on the “page-turning count” (S122) will be described later.

When the “page-turning count” is not set as the priority criterion (S121: NO), the CPU 50 determines whether the “page-turning count/page count” is set as the priority criterion (S123). When the “page-turning count/page count” is set as the priority criterion (S123: YES), the CPU 50 executes a sorting process based on the “page-turning count/page count” (S124) and then proceeds to S127 to be described later. The detail of the sorting process based on the “page-turning count/page count” of S124 will be described later.

When the “page-turning count/page count” is not set as the priority criterion (S123: NO), the CPU 50 determines whether the “time-of-day page-turning count” is set as the priority criterion (S125). When the “time-of-day page-turning count” is set as the priority criterion (S125: YES), the CPU 50 executes a sorting process based on the “time-of-day page-turning count” (S126) and then proceeds to S127. The detail of the sorting process based on the “time-of-day page-turning count” of S126 will be described later.

When the “time-of-day page-turning count” is not set as the priority criterion (S125: NO), the CPU 50 determines whether the “relevant degree” is set as the priority criterion (S127). When the “relevant degree” is set as the priority criterion (S127: YES), the CPU 50 executes a sorting process based on the “relevant degree” (S128) and returns to the list display process (S1, see FIG. 6). In the sorting process based on the “relevant degree”, the CPU 50 sorts the display-order list that has already been generated before proceeding to S128 and rearranges the order of the list such that content files having a high degree of relevance to one another are listed close to one another. The detail of the sorting process based on the “relevant degree” of S128 will be described later.

When the “relevant degree” is not set as the priority criterion (S127: NO), the CPU 50 returns to the list display process (S1, see FIG. 6). Note that, when neither the “page-turning count”, “page-turning count/page count” nor “time-of-day page-turning count” is selected as the priority criterion, the CPU 50 displays a list according to the Japanese syllabary in S13.

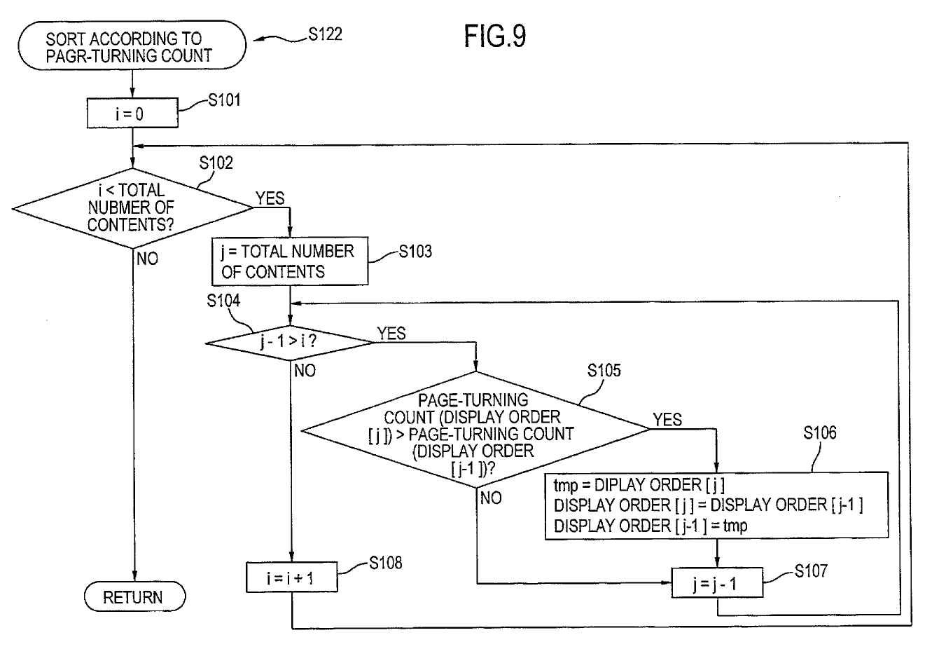

The sorting process based on the “page-turning count” will be described while referring to FIG. 9. FIG. 9 is a flowchart showing the sorting process based on the “page-turning count”.

Upon starting the sorting process based on the “page-turning count”, the CPU 50 sets 0 as a variable i (S101).

The CPU 50 then determines whether the variable i is smaller than the total number of contents stored in the storage medium 200 (S102). Since 0 is initially set as the variable i and 10 contents (from contents 1 to 10) are stored in the storage medium 200, the CPU 50 determines that the variable i is smaller than the total number of contents.

When the variable i is smaller than the total number of contents stored in the storage medium 200 (S102: YES), the CPU 50 sets the total number of contents as a variable j (S103).

Then, the CPU 50 determines whether a variable (j−1) is larger than the variable i (S104). When the variable (j−1) is larger than the variable i (S104: YES), the CPU 50 refers to the display order determination table of FIG. 4, compares the “page-turning count” of a j-th content file in the display-order list and “page-turning count” of a (j−1)-th content file in the display-order list, and determines whether the value of the “page-turning count” of the j-th content file is larger than the value of the “page-turning count” of the (j−1)-th content file (S105).

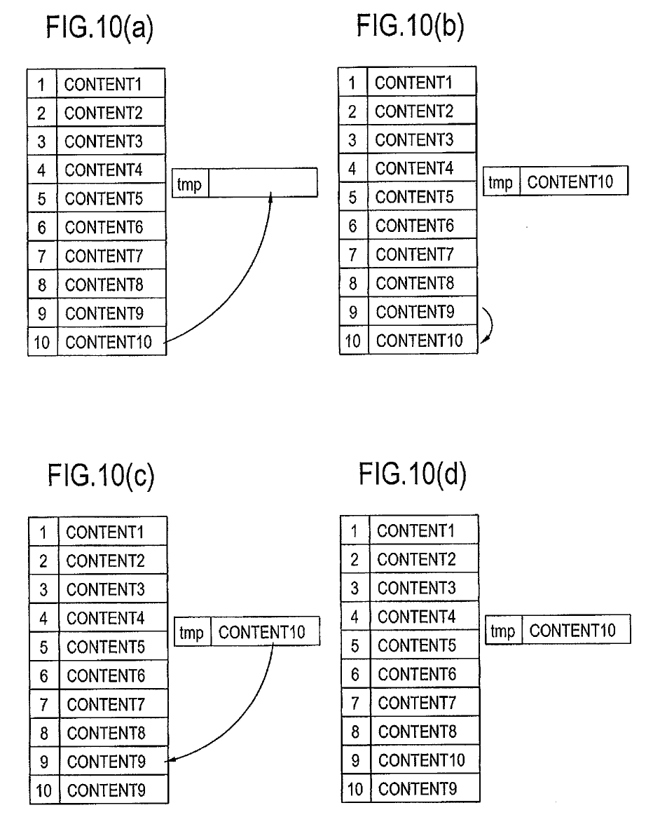

When the value of the “page-turning count” of the j-th content file is larger than the value of the “page-turning count” of the (j−1)-th content file (S105: YES), the CPU 50 interchanges the names of the j-th content file and the (j−1)-th content file in the display-order list (S106). As an example, a case where the names of the 10th content file and the 9th content file in the display-order list shown in FIG. 7 are interchanged in S106 will be described with reference to FIGS. 10(a) to 10(d). First, as shown in FIG. 10(a), “content 10”, which is the name of the 10th content file, is set in the area of a variable tmp. Secondly, as shown in FIG. 10(b), “content 9”, which is the name of the 9th content file, is set in the 10th area of the display-order list. Finally, as shown in FIG. 10(c), “content 10”, which is the name of the content file set in the area of the variable tmp, is set in the 9th area of the display-order list. In this way, as shown in FIG. 10(d), generated is the display-order list in which the orders of the 10th content file and the 9th content file have been interchanged.

After sorting the orders of the content files as described above, the CPU 50 decrements the value of the variable j by 1 (S107) and returns to S104.

When the value of the “page-turning count” of the j-th content file is smaller than the value of the “page-turning count” of the (j−1)-th content file (S105: NO), the CPU 50 directly proceeds to S107 without interchanging the orders of the j-th and the (j−1)-th content files.

For example, after the names of 10th and 9th content files are interchanged in S106, the value of the variable j is decremented by 1 in S107 and therefore becomes 9. Then, because the variable i is 0 while the variable j becomes 9, the CPU 50 determines YES in S104. Accordingly, in S105, the value of the “page-turning count” of the 9th content file and value of the “page-turning count” of the 8th content file are compared.

By repeating the steps from S104 to S107 in this way, the name of the content file having the largest “page-turning count” value among the (i+1)-th to the 10th (last) content files is moved to the (i+1)-th position in the display-order list. Since 0 is initially set as the variable i, the name of the content file having the largest “page-turning count” value among the 1st to 10th content files is moved to the top of the display-order list.

When the variable j is smaller than the variable i (S104; NO), the CPU 50 increments the value of the variable i by 1 (S108) and returns to S102. Then, the CPU 50 executes the steps from S102 and S103 in the same manner as above and subsequently repeats the steps from S104 to S107. As a result, as in the case described above, the name of the content file having the largest “page-turning count” value among the (i+1)-th to 10th content files is moved to the (i+1)-th position in the display-order list. For example, when i is 1, the name of the content file having the largest “page-turning count” value among the 2nd to 10th content files is moved to the 2nd position in the display-order list.

The CPU 50 then repeats the steps from S103 to S108 until the value of the variable i exceeds the total number of contents in S102 to sort the names of the content files in descending order in terms of the “page-turning count”. As a result, the CPU 50 can display a list in which the content files are arranged in descending order in terms of the “page-turning count”. When the value of the variable i exceeds the total number of contents (S102: NO), the CPU 50 returns to the priority calculation process (S12, see FIG. 8).

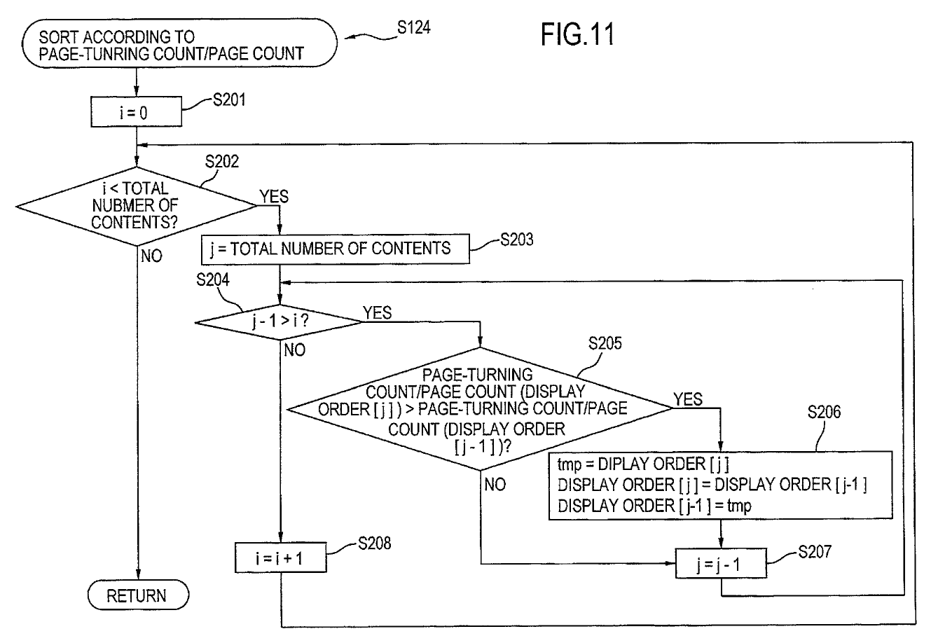

The sorting process based on the “page-turning count/page count” will be described next while referring to FIG. 11. FIG. 11 is a flowchart of the sorting process based on the “page-turning count/page count”.

After starting the sorting process based on the “page-turning count/page count”, the CPU 50 first sets 0 as a variable i (S201).

The CPU 50 then determines whether the variable i is smaller than the total number of contents stored in the storage medium 200 (S202). Since 0 is initially set as the variable i and 10 contents (from contents 1 to 10) are stored in the storage medium 200, the CPU 50 determines that the variable i is smaller than the total number of contents.

When the variable i is smaller than the total number of contents stored in the storage medium 200 (S202: YES), the CPU 50 sets the total number of contents as a variable j (S203).

Then, the CPU 50 determines whether a variable (j−1) is larger than the variable i (S204). When the variable (j−1) is larger than the variable i (S204: YES), the CPU 50 refers to the display order determination table shown in FIG. 4, compares the value of the “page-turning count/page count” of a j-th content file in the display-order list and the value of the “page-turning count/page count” of a (j−1)-th content file in the display-order list, and determines whether the value of the “page-turning count/page count” of the j-th content file is larger than the value of the “page-turning count/page count” of the (j−1)-th content file (S205).

When the value of the “page-turning count/page count” of the j-th content file is larger than the value of the “page-turning count/page count” of the (j−1)-th content file (S205: YES), the CPU 50 interchanges the names of the j-th and (j−1)-th content files in the display-order list (S206). The interchange of the names is performed in the same manner as the interchange of the names performed in the sorting process based on the “page-turning count” which has been described with reference to FIGS. 10(a) to 10(d).

After interchanging the orders of the content files as described above, the CPU 50 decrements the value of the variable j by 1 (S207) and returns to S204.

When the value of the “page-turning count/page count” of the j-th content file is smaller than the value of the “page-turning count/page count” of the (j−1)-th content file (S205: NO), the CPU 50 directly proceeds to S207 without interchanging the names of the j-th and (j−1)-th content files.

When the variable j is smaller than the variable i (S204: NO), the CPU 50 increments the value of the variable i by 1 (S208) and returns to S202.

The CPU 50 then repeats the steps from S203 to S208 until the value of the variable i exceeds the total number of contents in S202 to sort the names of the content files in descending order in terms of the “page-turning count/page count”. As a result, a change in the page-turning count caused by a change in the volume of the information (number of pages) can be reflected in the display-order list. When the value of the variable i exceeds the total number of contents (S202: NO), the CPU 50 returns to the priority calculation process (S12, see FIG. 8).

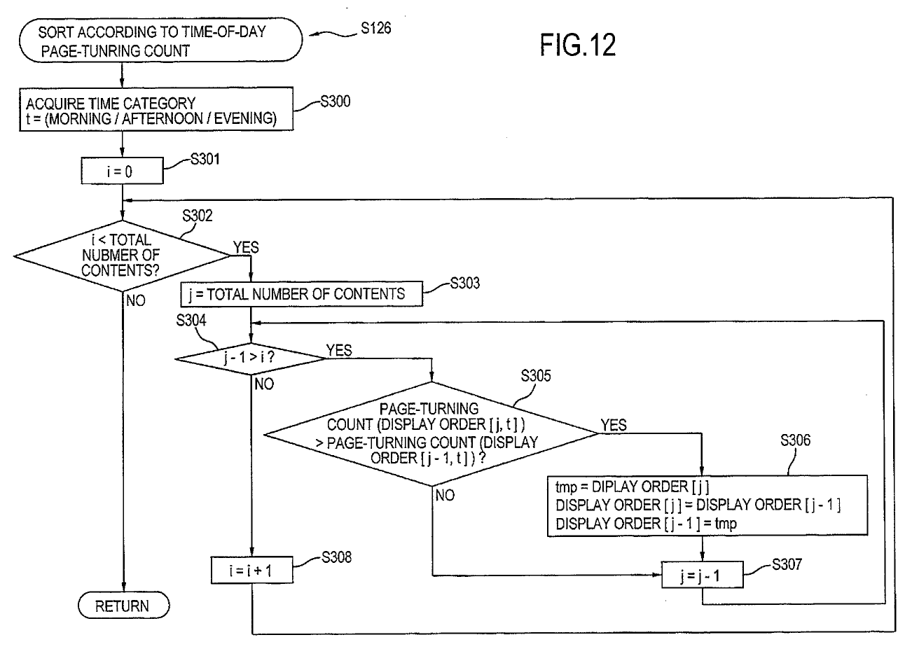

The sorting process based on the “time-of-day page-turning count” will be described with reference to FIG. 12. FIG. 12 is a flowchart of the sorting process based on the “time-of-day page-turning count”.

Upon starting the sorting process based on the “time-of-day page-turning count”, the CPU 50 first acquires current time measured by the 24-hour timer 60 and sets one of the three time categories “morning”, “afternoon”, and “evening” as a variable t, based on the measured current time, i.e., which time category the current time falls into (S300). Next, the CPU 50 sets 0 as a variable i (S301).

The CPU 50 then determines whether the variable i is smaller than the total number of contents stored in the storage medium 200 (S302). Since 0 is initially set as the variable i and 10 contents (from contents 1 to 10) are stored in the storage medium 200, the CPU 50 determines that the variable i is smaller than the total number of contents.

When the variable i is smaller than the total number of contents stored in the storage medium 200 (S302: YES), the CPU 50 sets the total number of contents as a variable j (S303).

Then, the CPU 50 determines whether a variable (j−1) is larger than the variable i (S304). When the variable (j−1) is larger than the variable i (S304: YES), the CPU 50 refers to the display order determination table of FIG. 4, and compares the value of the “page-turning count” in the current time category set as the variable t (i.e., any one of “page-turning count (morning)”, “page-turning count (afternoon)”, and “page-turning count (evening)” corresponding to the current time category) of a j-th content file and the value of the “page-turning count” in the current time category (i.e., any one of “page-turning count (morning)”, “page-turning count (afternoon)”, and “page-turning count (evening)” corresponding to the current time category) of a (j−1)-th content file, and determines whether the value of the “page-turning count” of the j-th content file in the current time category is larger than the value of the “page-turning count” of the (j−1)-th content file in the current time category (S305).

For example, when the variable t indicates “morning”, information of “page-turning count (morning)” for each content file stored in the display order determination table is compared to one another.

When the value of the “page-turning count” of the j-th content file in the current time category is larger than the value of the “page-turning count” of the (j−1)-th content file in the current time category (S305: YES), the CPU 50 interchanges the names of the j-th and (j−1)-th content files in the display-order list (S306). The interchange of the names is performed in the same manner as the interchange of the names performed in the sorting process based on the “page-turning count” which has been described using FIGS. 10(a) to 10(d).

After sorting the orders of content files as described above, the CPU 50 decrements the value of the variable j by 1 (S307) and returns to S304.

When the value of the “page-turning count” of the j-th content file in the current time category is smaller than the value of the “page-turning count” of the (j−1)-th content file in the current time category (S305: NO), the CPU 50 directly proceeds to S307 without interchanging the names of the j-th and (j−1)-th content files.

When the variable j becomes smaller than the variable i (S304: NO), the CPU 50 increments the value of the variable i by 1 (S308) and returns to S302.

The CPU 50 then repeats the steps from S303 to S308 until the value of the variable i exceeds the total number of contents in S302 to sort the names of the content files in descending order in terms of “page-turning count” in the current time category, i.e., any one of “page-turning count (morning)”, “page-turning count (afternoon)”, and “page-turning count (evening)”. As a result, an order of content files is determined according to the operation information in each time category, thereby enabling a list to be displayed in which the content files are arranged in descending order in terms of importance for a user in the current time category. When the value of the variable i exceeds the total number of contents (S302: NO), the CPU 50 returns to the priority calculation process of S12 (see FIG. 8).

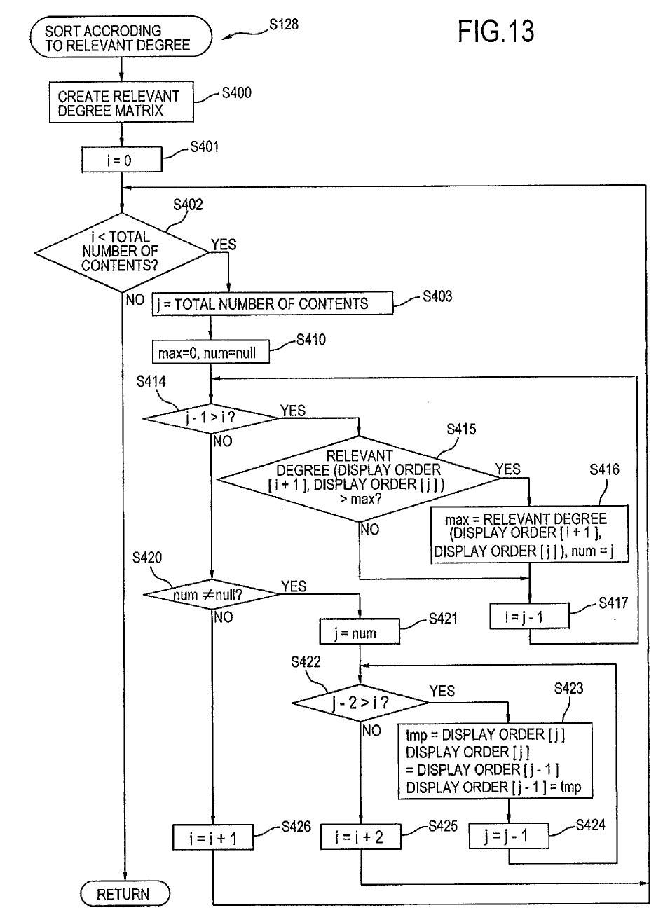

The sorting process based on the relevant degree will be described using FIG. 13. FIG. 13 is a flowchart of the sorting process based on the relevant degree.

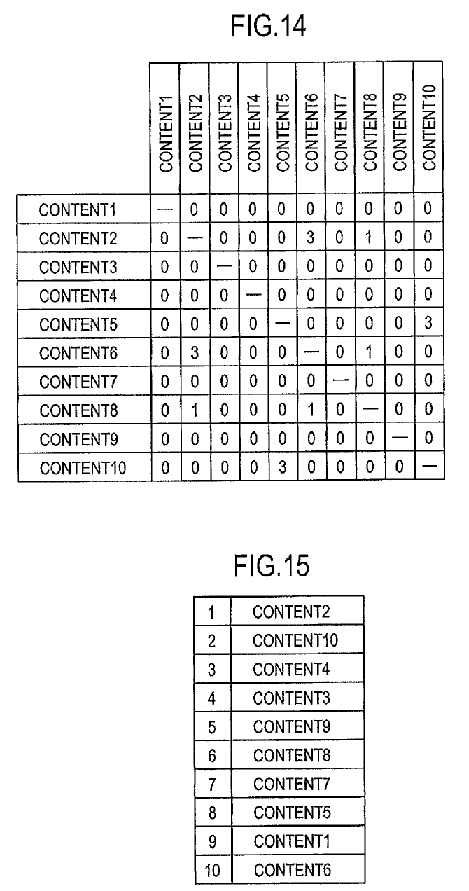

Upon starting the sorting process based on the relevant degree, the CPU 50 first refers to the “tag” information shown in the display order table of FIG. 4 and creates a relevant degree matrix as shown in FIG. 14 (S400).

As shown in FIG. 14, the relevant degree matrix stores a number of keywords common to two content files in two matrix cells shared between the corresponding two content files, as a value of the relevant degree.

For example, referring to the display order determination table (FIG. 4), the “tag” information for the content file 2 includes three keywords: “news”, “topic”, and “company B”, while the “tag” information for the content file 6 includes three keywords: “news”, “topic”, and “company B”. That is, three keywords are common to the content files 2 and 6, so that “3” is stored in the matrix cells shared between the content files 2 and 6.

Further, for example, a keyword “company B” is common to the content files 2 and 8, so that “1” is stored in the matrix cells shared between the content files 2 and 8. Further, for example, there is no keyword common to the content files 2 and 10, so that “0” is stored in the matrix cells shared between the content files 2 and 10.

After creating the relevant degree matrix in S400, the CPU 50 sets 0 as a variable i (S401) and determines whether the variable i is smaller than the total number of contents stored in the storage medium 200 (S402). Since 0 is initially set as the variable i and 10 contents (from contents 1 to 10) are stored in the storage medium 200, the CPU 50 determines that the variable i is smaller than the total number of contents.

When the variable i is smaller than the total number of contents stored in the storage medium 200 (S402: YES), the CPU 50 sets the total number of contents as a variable j (S403).

Then, the CPU 50 sets 0 as a variable max and null as a variable num (S410), and determines whether a variable (j−1) is larger than the variable i (S414). When the variable (j−1) is larger than the variable i (S414: YES), the CPU 50 refers to the relevant degree matrix and determines whether the value of the relevant degree between a (i+1)-th content file and a j-th content file in the display-order list is larger than the variable max (S415).

When the value of the relevant degree between the (i+1)-th and the j-th content files in the display-order list is larger than the variable max (S415: YES), the CPU 50 sets the value of the relevant degree as the variable max, and also sets the value of the variable j as the variable num (S416). Subsequently, the CPU 50 decrements the value of the variable j by 1 (S417) and returns to S414.

When the value of the relevant degree between the (i+1)-th and the j-th content files in the display-order list is smaller than the variable max (S415: NO), the CPU 50 directly proceeds to S417.

Repeating the loop from S414 to S417 can determine which one of the content files, from the (i+2)-th to the last (j-th) content files, has the strongest relevance to the (i+1)-th content file.

When the variable j becomes smaller than the variable i (S414: NO), the CPU 50 determines whether the variable num is not equal to null (S420).

When the variable num is not equal to null (S420: YES), the CPU 50 sets the value of the variable num as the variable j (S421) and determines whether a value obtained by subtracting 2 from the variable j is larger than the variable i (S422).

When the value obtained by subtracting 2 from the variable j is larger than the variable i (S422: YES), the CPU 50 interchanges the names of the j-th and the (j−1)-th content files in the display-order list (S423). Note that the process of S423 is the same as the process of S106 of FIG. 9. The description thereof is therefore omitted here.

Then, the CPU 50 decrements the value of the variable j by 1 (S424) and returns to S422. By repeating the loop from S422 to S424, a name of the content file having the strongest relevance to the (i+1)-th content file can be listed immediately after the name of the (i+1)-th content file. As a result, an image of the list in which content files having a high degree of relevance are arranged close to each other can be displayed.

When the value obtained by subtracting 2 from the variable j is not larger than the variable i (S422: NO), the CPU 50 increments the value of the variable i by 2 (S425) and returns to S402.

When the variable num is equal to null (S420: NO), the CPU 50 increments the value of the variable i by 1 (S426) and returns to S402.

When the value of the variable i becomes larger than the total number of contents (S402: NO), the CPU 50 returns to the priority calculation process (S12, see FIG. 8).

Here, in the sorting process based on the relevant degree described above, how the display-order list in which the content files are arranged in the order of Japanese syllabary is sorted will be described using, as an example, a case where the “page-turning count” and “relevant degree” are selected as the priority criterion.

If the “page-turning count” is selected as the priority criterion, the CPU 50 determines YES in S121 of the priority calculation process shown in FIG. 8 and then proceeds to S122. Then, in the sorting process based on the “page-turning count” of S122, the CPU 50 refers to the display order determination table of FIG. 4, and sorts, in descending order in terms of the “page-turning count”, the display-order list in which the content files are arranged in the order of Japanese syllabary. The obtained display-order list is as shown in FIG. 15.

In the display-order list sorted in S122 as shown in FIG. 15, the content files 1 to 10 are arranged from the top in the order of “content 2”, “content 10”, “content 4”, “content 3”, “content 9”, “content 8”, “content 7”, “content 5”, “content 1”, and “content 6”, i.e., in descending order in terms of the “page-turning count”.

After sorting the display-order list in this way in S122, the CPU 50 determines YES in S127 since the relevant degree is selected as the priority criterion, and executes the sorting process based on the relevant degree (S128).

After starting the sorting process based on the relevant degree (S128), the CPU 50 creates the relevant degree matrix as shown in FIG. 14 (S400, see FIG. 13) and sets 0 as the variable i (S401).

Since the variable i is 0 and the total number of contents is 10, the CPU 50 determines that the variable i is smaller than the total number of contents (S402: YES) and sets 10 (total number of contents) as the variable j (S403).

Then, the CPU 50 sets 0 as the variable max and null as the variable num (S410). Since 10 has been set as the variable j and 0 has been set as the variable i, the CPU 50 determines that the variable (j−1) is larger than the variable i (S414: YES). Subsequently the CPU 50 determines whether the value of the relevant degree between the (i+1)-th and j-th content files in the display-order list is larger than the variable max (S415).

In this case, 0 and 10 have been set as the variable i and the variable j, respectively. Accordingly, the CPU 50 determines whether the value of the relevant degree between the 1st content file and the 10th (last) content file in the display-order list is larger than the variable max.

In this example, as shown in FIG. 15, the 1st content file is a content file 2 and the 10th content file is a content file 6.

Thus, in S415, the CPU 50 refers to the relevant degree matrix (FIG. 14) and determines whether the value of the relevant degree between the content files 2 and 6 is larger than the variable max.

Since the value of the relevant degree between the content files 2 and 6 is 3 as shown in FIG. 14 and 0 has been set as the variable max, the CPU determines YES in S415 and sets 3 (value of the relevant degree) as the variable max and sets 10 (order of the content file 6) as the variable num (S416). Subsequently, the CPU 50 decrements the value of the variable j by 1, i.e., sets 9 as the variable j (S417) and returns to S414.

The CPU 50 then determines once again whether the variable (j−1) is larger than the variable i in S414. In this case, since 9 and 0 have been set as the variable j and variable i, respectively, the CPU 50 determines that the variable (j−1) is larger than the variable i (S414: YES).

Then, in S415, the CPU 50 determines whether the value of the relevant degree between the 1st and 9th content files (i.e., content files 2 and 1) in the display-order list is larger than the variable max (S415).

When the value of the relevant degree between the (i+j)-th and the j-th content files becomes smaller than the variable max in S415 in the course of repetition of the loop from S414 to S417 (S415: NO), the CPU 50 decrements the value of the variable j by 1 (S417) and returns to s414.

As described above, in the course of repetition of the loop from S414 to S417, the CPU 50 determines in S415 whether the value of the relevant degree between the 1st content file and another content file in the display-order list is larger than the variable max. The CPU 50 compares, with the variable max, each one of the values of the relevant degree between respective one of the content files and the top-listed content file, sequentially from the bottom of the list.

By repeating the loop from S414 to S417 until the value of the variable i exceeds the value of the variable (j−1), the CPU 50 sets, as the variable num, the order of the content file having the strongest relevance to the (j+1)-th content file in the display-order list.

The content file having the strongest relevance to the content file 2, 1st content file, is the content file 6 and the order of the content file 6 in the display-order list is 10. Therefore 10 (order of the content file 6) has been set as the variable num after the loop from S414 to S417 is finished.

After setting the order of the content file having the strongest relevance to the (i+1)-th content file as the variable num as described above, the CPU 50 determines whether the variable num is not equal to null in S420.

The CPU 50 determines that the variable num is equal to null (NO: S420) when no content file having a relevance to the (i+1)-th content file has been found during the loop from S414 to S417.

When 10 has been set as the variable num, the CPU 50 determines YES in S420 and sets 10 (value of the variable num) as the variable j once again.

Then, the CPU 50 repeats the loop from S422 to S424 until the value obtained by subtracting 2 from the variable j becomes smaller than the value of the variable i in S422.

In this case, since 0 has been set as the variable i and 10 has been set as the variable j, the CPU 50 repeats the loop from S422 to S424 eight times.

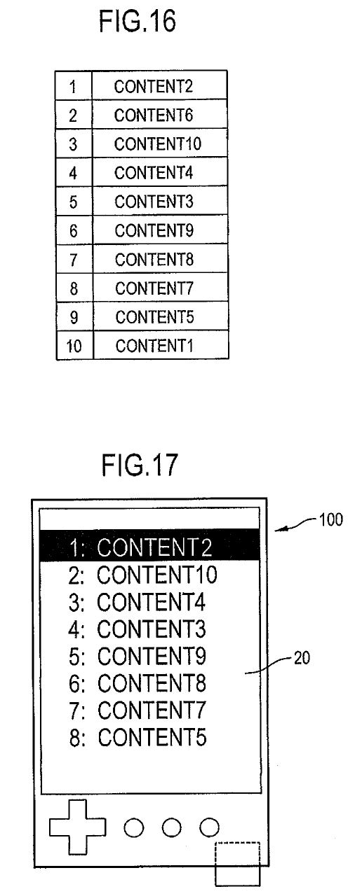

The CPU 50 interchanges the orders of the j-th content file and the (j−1)-th content file in the display-order list as described above in S423. Accordingly, by repeating the loop from S422 to S424 eight times, a display-order list as shown in FIG. 16 is generated. In the display-order list, the content file 6 is placed immediately below the content file 2.

In the display-order list of FIG. 16, the content files 1 to 10 are arranged from the top in the order of “content 2”, “content 6”, “content 10”, “content 4”, “content 3”, “content 9”, “content 8”, “content 7”, “content 5”, and “content 1”.

After placing the content 6 having the strongest relevance to the 1st content file 2 immediately below the 1st content file 2, the CPU 50 increments the variable i by 2 and proceeds to S402. That is, in the subsequent loop starting from S402, the CPU 50 finds a content file having the strongest relevance to the 3rd content file in the display-order list shown in FIG. 16 (in this case, the content file 10) from the rest of the content files listed after the 4th content file, and places the found content file in the 4th position of the list.

In the following, examples of a screen displayed on the display panel 20 as a result of the list display process of S1 (see FIG. 6) according to the display-order list generated in the above priority calculation process are shown.

FIG. 17 is a view showing the display apparatus that displays a list of the content files when the “page-turning count” is set as the priority criterion but the “relevant degree” is not set as the priority criterion. As shown in FIG. 17, the content files are displayed on the display panel 20 in descending order in terms of the “page-turning count” stored in the display order determination table; that is, in the order of, from the top, “content 2”, “content 10”, “content 4”, “content 3”, “content 9”, “content 8”, “content 7”, and “content 5”.

In the present embodiment, because only top eight names of the content files in the display-order list are displayed, “content 1” and “content 6” having small numbers of the “page-turning count” are not displayed on the display panel 20 in FIG. 17. That is, the content files unnecessary for a user are not displayed. However, all the names of the content files may be displayed.

When a list of content files is displayed for the first time in S13, the name of the top (1st) content file is highlighted. When the determination button 42 is depressed in this state, the screen currently displayed is switched to a screen displaying the content of the top (1st) content file.

The highlighted area can move up and down by depressing the upper and lower portions of the cross key 41, thereby enabling a user to select a desired content file from the list of the content files.

As shown in FIG. 17, numbers indicating orders of each content file are displayed respectively on the left side of the corresponding content file names.

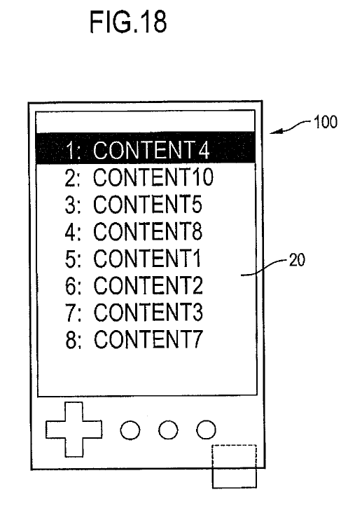

FIG. 18 is a view showing the display apparatus that displays a list of the content files when the “page-turning count/page count” is set as the priority criterion but the “relevant degree” is not set as the priority criterion. As shown in FIG. 18, the content files are displayed on the display panel 20 in descending order in terms of the “page-turning count/page count” stored in the display order determination table; that is, in the order of, from the top, “content 4”, “content 10”, “content 5”, “content 8”, “content 1”, “content 2”, “content 3”, and “content 7”.

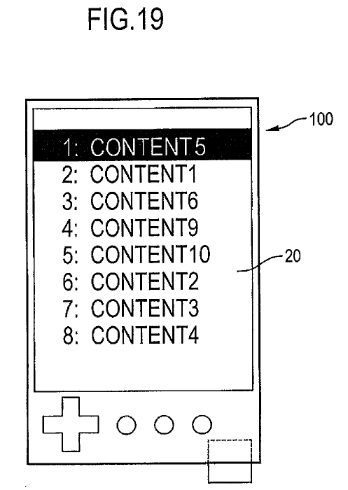

FIG. 19 is a view showing the display apparatus that displays a list of the content files when the “time-of-day page-turning count” is set as the priority criterion but the “relevant degree” is not set as the priority criterion. Note that the current time category is “morning” in this case. As shown in FIG. 19, the content files are displayed on the display panel 20 in descending order in terms of the “page-turning count (morning)” stored in the display order determination table; that is, in the order of, from the top, “content 5”, “content 1”, “content 6”, “content 9”, “content 10”, “content 2”, “content 3”, and “content 4”.

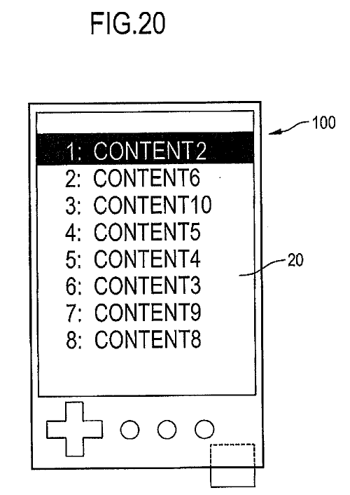

FIG. 20 is a view showing the display apparatus that displays a list of the content files when the “page-turning count” and “relevant degree” are selected as the priority criterion. As shown in FIG. 20, “content 2” having the largest value of “page-turning count” is displayed at the top. Displayed immediately below the content 2 is “content 6” having the strongest relevance to the content 2. Displayed immediately below the content 6 is “content 10” having the largest value of “page-turning count” among all the content files except the content 2 and content 6. Displayed immediately below the content 10 is “content 5” having the strongest relevance to the content 10. Displayed immediately below the content 5 is “content 4” having the largest value of “page-turning count” among all the content files except the content 2, content 6, content 10, and content 5. Since no content file having a relevance to the content 4 exists, “content 3” having the largest value of “page-turning count” among all the content files except the content 2, content 6, content 10, content 5 and content 4 is displayed immediately below the content 4. Since no content file having a relevance to the content 3 exists, “content 9” having the largest value of “page-turning count” among all the content files except the content 2, content 6, content 10, content 5, content 4 and content 3 is displayed immediately below the content 3. Since no content file having a relevance to the content 9 exists, “content 8” having the largest value of “page-turning count” among all the content files except the content 2, content 6, content 10, content 5, content 4, content 3 and content 9 is displayed immediately below the content 9.

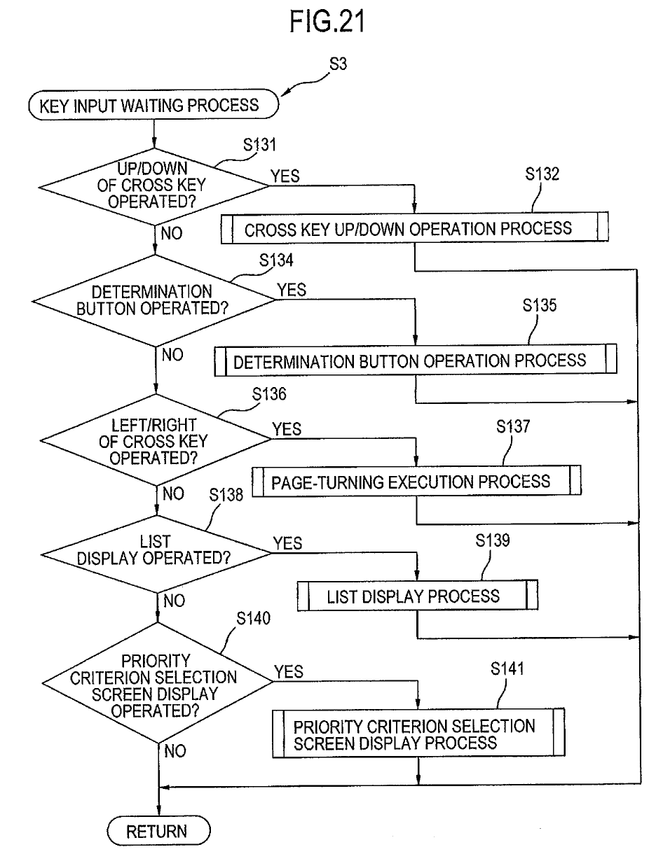

The detail of the key input waiting process of S3 in the main process (see FIG. 5) will be described next. FIG. 21 is a flowchart of the key input waiting process.

As shown in FIG. 21, upon starting the key input waiting process, the CPU 50 determines whether an up/down operation of the cross key 41 has been performed, that is, whether the upper portion or lower portion of the cross key 41 has been depressed (S131). When the up/down operation of the cross key 41 has been performed (S131: YES), the CPU 50 executes a cross key up/down operation process (S132) to be described later and returns to the main process (FIG. 5).

When the up/down operation of the cross key 41 has not been performed (S131: NO), the CPU 50 determines whether the determination button has been operated, that is, whether the determination button 42 has been depressed (S134). When the determination button has been operated (S134: YES), the CPU 50 executes a determination button operation process (S135) to be described later and returns to the main process (FIG. 5).

When the determination button has not been operated (S134: NO), the CPU 50 determines whether a left/right operation of the cross key 41 has been performed, that is, whether the left portion or right portion of the cross key 41 has been depressed (S136). When the left/right operation of the cross key 41 has been performed (S136: YES), the CPU 50 executes page-turning execution process (S137) to be described later and returns to the main process (FIG. 5).

When the left/right operation of the cross key 41 has not been performed (S136: NO), the CPU 50 determines whether a list display operation has been instructed, that is, whether the list display button 43 has been depressed (S138). When the list display operation has been instructed (S138: YES), the CPU 50 executes the list display process (S139) and returns to the main process (FIG. 5). The list display process mentioned here is the same as the list display process in S1 (see FIG. 6) and the description thereof is omitted here.

When the list display operation has not been instructed (S138: NO), the CPU 50 determines whether a priority criterion selection screen display operation has been instructed, that is, the selection screen display button 44 has been depressed (S140). When the priority criterion selection screen display operation has been instructed (S140: YES), the CPU 50 displays a priority criterion selection screen on the display panel 20 (S141) and returns to the main process.

When the priority criterion selection screen display operation has not been instructed (S140: NO), the CPU 50 directly returns to the main process.

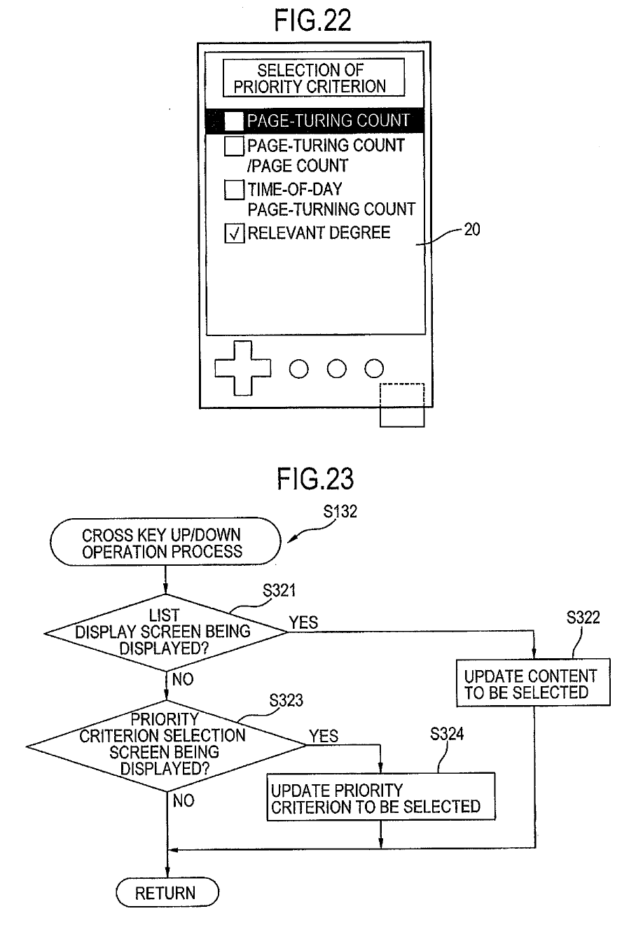

Here, the priority criterion selection screen will be described. FIG. 22 is a front view of the display apparatus 100 that displays the priority criterion selection screen. As shown in FIG. 22, four items of the priority criterion: “page-turning count”, “page-turning count/page count”, “time-of-day page-turning count”, and “relevant degree” are displayed on the priority criterion selection screen.

A check box is provided on the left side of each item. The check box corresponding to the item currently in effect is checked with a check mark.

The item currently being selected is highlighted on the priority criterion selection screen. The item being selected can be changed to another item by the up/down operation of the cross key 41. When the determination button 42 is depressed, a check mark is added to the check box corresponding to the highlighted item that is being selected, whereby the item corresponding to the checked check box is selected as the priority criterion.

With regard to the “page-turning count”, “page-turning count/page count”, and “time-of-day page-turning count”, any one of the above three items can be set independently as the priority criterion. “Relevant degree” can be set as the priority criterion in combination with any one of the above three items.

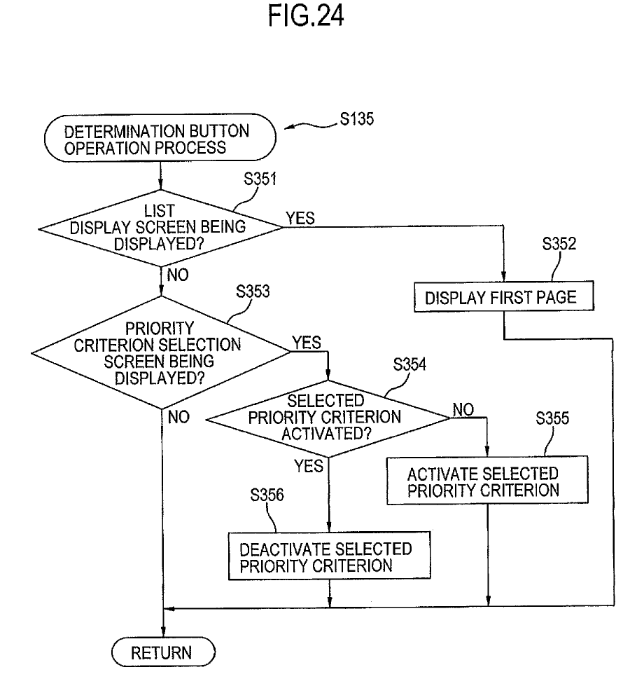

The cross key up/down operation process will be described. FIG. 23 is a flowchart of the cross key up/down operation process of S132.

Upon starting the cross key up/down operation process, the CPU 50 determines whether the list display screen is being displayed on the display panel 20 (S321). When the list display screen is being displayed (S321: YES), the CPU 50 updates a content highlighted to be selected (S322) and returns to the key input waiting process of S3. For example, when the lower portion of the cross key 41 is depressed in S131 while the list display screen on which “content 2” is highlighted as shown in FIG. 17 is being displayed, the CPU 50 moves down the highlighted bar to “content 10” in S322.

When the list display screen is not being displayed (S321: NO), the CPU 50 determines whether the priority criterion selection screen is being displayed (S323). When the priority criterion selection screen is being displayed (S323: YES), the CPU 50 updates the item highlighted to be selected as the priority criterion (S324) and returns to the key input waiting process of S3. For example, when the lower portion of the cross key 41 is depressed in S131 while the priority criterion selection screen on which the “page-turning count” is highlighted as shown in FIG. 22 is being displayed, the CPU 50 moves down the highlighted bar to the “page-turning count/page count” in S324.

When the priority criterion selection screen is not being displayed (S323: NO), the CPU 50 directly returns to the key input waiting process of S3.

The determination button operation process (S135) will be described. FIG. 24 is a flowchart of the determination button process. When starting the determination button process of S135, the CPU 50 first determines whether the list display screen is being displayed (S351). When the list display screen is being displayed (S351: YES), the CPU 50 displays the first page of the page data of the highlighted content on the display panel 20 (S352) and returns to the key input waiting process of S3.

When the list display screen is not being displayed (S351: NO), the CPU 50 determines whether the priority criterion selection screen is being displayed (S353). When the priority criterion selection screen is being displayed (S353: YES), the CPU 50 determines whether the selected priority criterion is activated (whether the check box has been checked) (S354).

When the selected priority criterion is not activated (S354: NO), the CPU 50 activates the selected priority criterion (S355) and returns to the key input waiting process of S3.

When the selected priority criterion is activated (S354: YES), the CPU 50 deactivates the selected priority criterion (S356) and returns to the key input waiting process of S3.

When the priority criterion selection screen is not being displayed (S353: NO), the CPU 50 directly returns to the key input waiting process of S3.

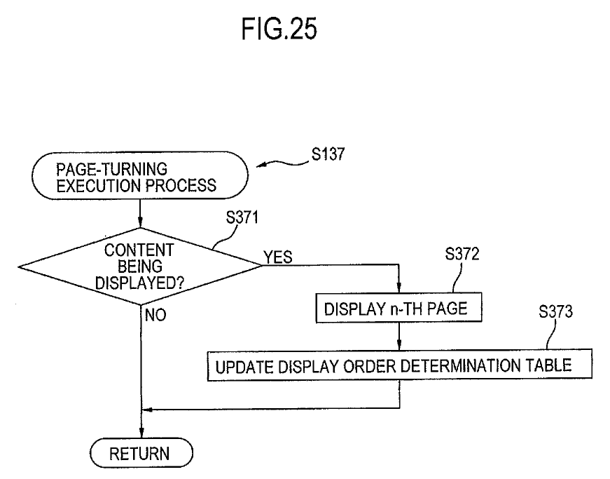

The page-turning execution process (S137) will be described. FIG. 25 is a flowchart of the page-turning execution process. When starting the page-turning execution process of S137, the CPU 50 first determines whether any content is being displayed based on the page data of the corresponding content file (S371). When any content is being displayed (S371: YES), the CPU 50 changes the page data to be displayed in accordance with the direction of the cross key 41 depressed in S136 (S372). For example, if the left portion of the cross key 41 is depressed in S136 while the second page of page data is being displayed, the page data for the next page (i.e., third page) is displayed on the display panel 20. Further, for example, if the right portion of the cross key 41 is depressed in S136 while the second page of page data is being displayed, the page data for the preceding page (i.e., first page) is displayed on the display panel 20.

After updating the page data to be displayed in this way, the CPU 50 updates the display order determination table (S373) and returns to the key input waiting process. In S373, the CPU 50 updates the “page-turning count” and “page-turning count/page count” in the display order determination table shown in FIG. 4. More specifically, the CPU 50 increments the value of the “page-turning count” by 1 and sets a new value as the “page-turning count/page count”. Here, the CPU 50 sets a value obtained by dividing the value of the “page-turning count”, which has been incremented by 1, by the value of the “page count”.

With regard to the “page-turning count (morning)”, “page-turning count (afternoon)”, and “page-turning count (evening)”, when the page data to be displayed in S372 is updated in the morning time category, the CPU 50 increments the value of the “page-turning count (morning)” by 1. When the page data to be displayed in S372 is updated in the afternoon time category, the CPU 50 increments the value of the “page-turning count (afternoon)” by 1. When the page data to be displayed in S372 is updated in the evening time category, the CPU 50 increments the value of the “page-turning count (evening)” by 1.

The display order determination table is updated every time a page-turning operation is executed as described above. Accordingly, a list in which the content files are arranged in the order of importance for a user can always be displayed in the list display process.

The display apparatus and storage medium storing the display program according to the present invention are not limited to the above embodiment but can be variously modified without departing from the spirit and scope of the invention. For example, although the display order determination table is stored in the storage medium 200 in the above embodiment, the display order determination table may be stored in an auxiliary storage section such as a hard disk provided in the display apparatus 100. Alternatively, a communication section for communicating with a server may be provided in the display apparatus 100 so that the display order determination table may be stored in an external server.

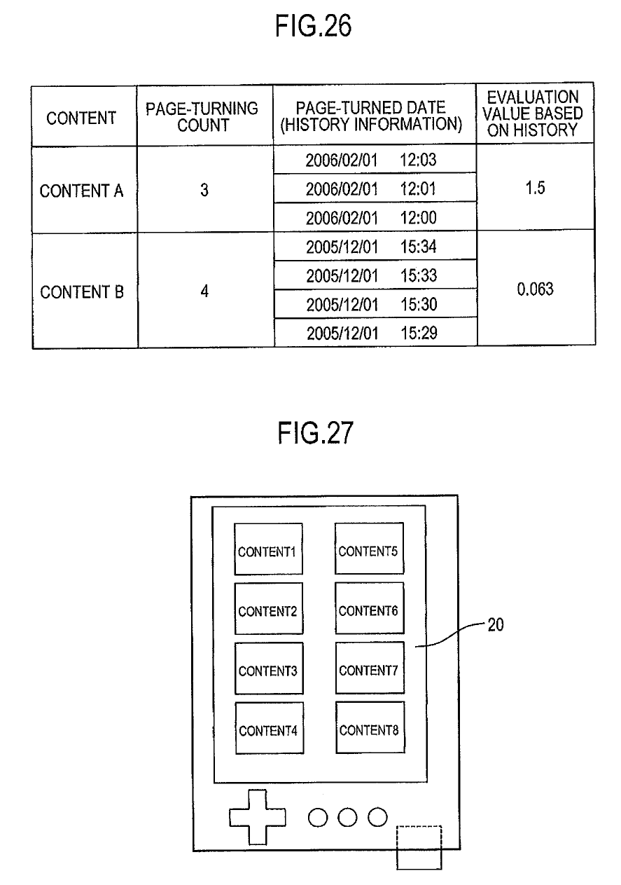

In the above embodiment, the display order of the content files is determined in accordance with the values of the “page-turning count”, “page-turning count/page count”, “page-turning count (morning)”, “page-turning count (afternoon)” and “page-turning count (evening)” as the operation information. All of these values are obtained based on the cumulative number of times of the page-turning operation. However, the display order may be determined by other operation information. Specifically, the CPU 50 may store the time when page-turning operations are executed for each content. Then the CPU 50 may weight the executed time of the page-turning operations according to the elapsed time from the executed time of the page-turning operations, and obtain an evaluation value by summing up the weighted values for each content. The display order is determined based on the evaluation value. The display order determination table according to this modification is shown in FIG. 26.

In the table of FIG. 26, the page-turning count for content A is 3, and page-turning count for content B is 4. Further, as the executed time of page-turning operations, “2006/02/01 12:00”, “2006/02/01 12:01”, and “2006/02/01 12:03” are stored for the content A, while “2005/12/01 15:29”, “2005/12/01 15:30”, “2005/12/01 15:33”, and “2005/12/01 15:34” are stored for the content B. 1.5 is stored as the evaluation value of the content A. The weighted value [1/(elapsed days+1)] is calculated for each page-turning operation, and these weighted values of all the page-turning operations are summed up to obtain the evaluation value. Note that the evaluation value in this case is obtained by assuming the current time is “2006/02/02 12:00”. That is, the evaluation value of 1.5 is obtained by (½)+(½)+(½). This evaluation value corresponds to the operation information. Likewise, the evaluation value for the content B is 0.063, which is obtained by ( 1/64)+( 1/64)+( 1/64)+( 1/64). As a result, the content files are displayed in the order of “content A” and “content B” according to the above evaluation values.

Although the display order is determined based on the value of the “page-turning count/page count” in the above embodiment, the display order may be determined by using a value obtained by subtracting the page count from the page-turning count.

Although the names of the content files are displayed from the top of the display-order list in descending order in S13 of the above embodiment, the way of displaying the list is not limited to the above. For example, the content files may be arranged from right to left. Alternatively, the thumbnails of each content may be displayed as shown in FIG. 27. In this case, the thumbnails of the contents are arranged vertically in two columns, starting from the top of the left column to the bottom of the right column. FIG. 27 shows a case in which the contents are arranged according to the Japanese syllabary.

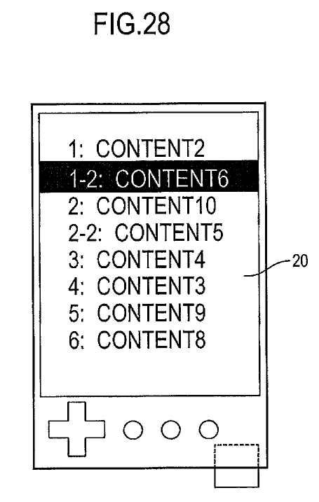

In the above embodiment, when the “page-turning count” and “relevant degree” are selected as the priority criterion, displayed in the list of content files are, sequentially from the top, “content 2”, “content 6”, “content 10”, “content 5”, “content 4”, “content 3”, “content 9” and “content 8”. At the same time, the numbers 1, 2, 3, 4, 5, 6, 7 and 8 are displayed in this order on the left side of each content file name, indicating the display order of the corresponding contents. However, the way of displaying the numbers indicating the display order of the respective contents may be modified such that the user can grasp, at glance, which content is sorted based on the relevant degree. For example, since “content 6” and “content 5” are sorted based on the relevant degree in the above embodiment, “1-2” and “2-2” are displayed respectively on the left side of the content 6 and content 5, as shown in FIG. 28.

In the above embodiment, a content file is made up of an index and a page data group. The index includes information such as the name of the content file, the number of pages, and link information navigating to respective page data. A plurality of page data (page unit data) constitutes the page data group, and the page data includes texts or images corresponding to one page to be displayed on the display panel 20. However, the content file may include a single data unit that includes texts or images corresponding to a plurality of pages, in stead of the page data group constituted by a plurality of page data including texts or images corresponding to one page. In such a case, an address for retrieving data corresponding to each page is set and, by specifying and retrieving the address, a displayed screen can be switched to another.

Although the display order is determined based on the cumulative number of times of the page-turning operation in the above embodiment, the display order may be determined based on the cumulative number of times of other operation, such as an enlarging operation for enlarging the display on the display panel.

Alternatively, as another operation, the display order may be determined based on a power on/off operation. A content may be displayed higher in a list, depending on the time category when the display apparatus is powered. As a result, for example, a content (e.g., Bible) to be read first in the morning can be displayed higher in the list.

Further, for example, a certain amount may be deducted from the number of times of a predetermined operation every time the power on/off operation is executed. In this case, the amount to be deducted may be determined by a subtraction of a predetermined amount, or a division at a constant rate. As a result, when the display order is determined, the operation information of a new operation can be highly weighted.

The predetermined operation information may be managed not only in the display apparatus but also in an external apparatus (e.g., server) after operation information is transmitted. This allows the operation information for contents to be shared, thereby enabling a service such as a survey on the popularity of contents to be provided. Further, a benefit (for example, an access authority to a specific content) may be provided to a user that has transmitted the operation information to the external apparatus.

Although the display order is determined based on the value obtained by dividing the page-turning count by the page count, the display order may be determined based on a value obtained by dividing the page-turning count by information amount, such as a byte count for a content file, instead of the page count.

Further, the display order may be determined with respect only to the content files that have been displayed at least once. In this case, the content files that have been displayed at least once and content files that have never been displayed are arranged respectively in different areas. An image of the list with respect only to the content files that have been displayed at least once is displayed according to the order determined based on the display order determination table. As described above, when the content files that have been displayed at least once and the content files that have never been displayed are displayed separately, information of read/unread (information indicating whether a content file has been read at least once or has never been read) may be stored in the storage medium 200 in association with each content file. The content files that have been displayed at least once and content files that have never been displayed are displayed separately based on the read/unread information. This configuration also allows the content files that have been displayed at least once and the content files that have never been displayed to be displayed distinctly in the list.

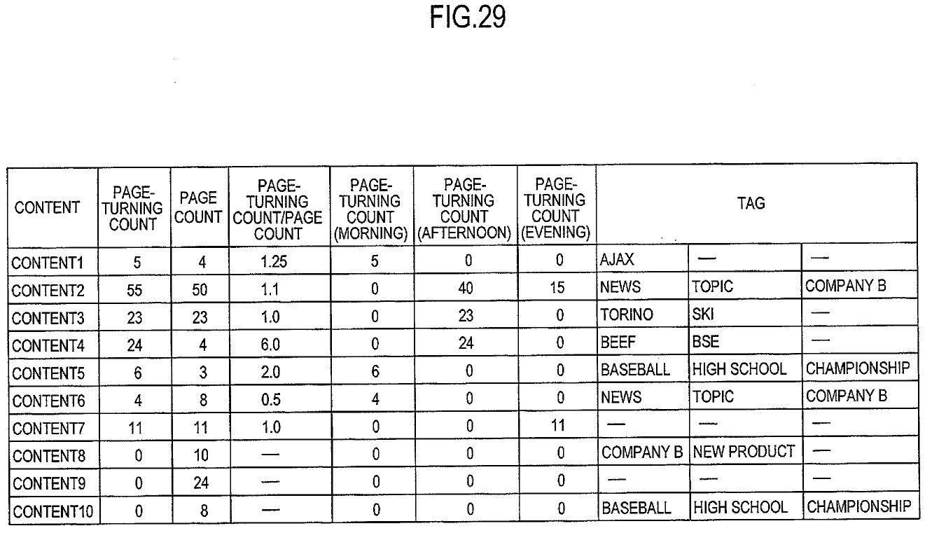

For example, as shown in the display order determination table of FIG. 29, “content 8”, “content 9” and “content 10” have never been displayed and, accordingly, 0 is set as the corresponding “page-turning count”, “page-turning count (morning)”, “page-turning count (afternoon)”, and “page-turning count (evening)”, and the value of the “page-turning count/page count” has not been calculated yet.

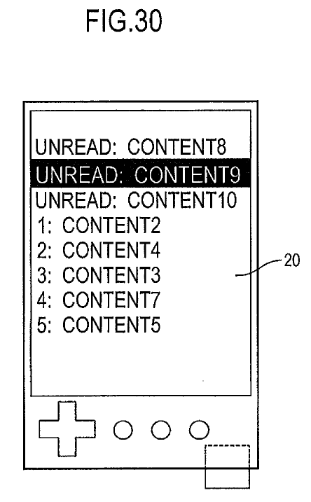

In this case, the list display may become as shown in FIG. 30. That is, on the display panel 20, “content 8”, “content 9”, and “content 10” that have never been displayed are displayed from the top according to the Japanese syllabary, followed by “content 2”, “content 4”, “content 3”, “content 7” and “content 5” in accordance with the order specified in the display-order list.

The list is displayed according to the Japanese syllabary in the above embodiment when neither the “page-turning count”, “page-turning count/page count”, nor “time-of-day page-turning count” is selected as the priority criterion. However, each content file may be configured to store the time when the content file was stored in the storage medium 200, and the list may be displayed according to the time. For example, the content files in the list may be arranged in reverse chronological order in terms of the time when the content files were stored in the storage medium 200.

Further, although the priority criterion can be selected from the “page-turning count”, “page-turning count/page count”, and “time-of-day page-turning count” in addition to the Japanese syllabary in the above embodiment, the display apparatus 100 may be configured such that the priority criterion cannot be selected. In this case, the display apparatus 100 determines the display order every time according to any one of the priority criterion items. Moreover, in the above embodiment, although the “relevant degree” can be set as the priority criterion in combination with any one of the other priority criteria, the “relevant degree” may be configured not to be selected as the priority criterion.

The display order determination table in the above embodiment may be stored as a part of the content file.

What is claimed is:

1. A display apparatus comprising:
a display section that displays a content including at least one of texts and images;
a first storage section that stores a plurality of content files;
a display controlling section that displays, on the display section, the content based on the plurality of content files;
a second storage section that stores, for each content file, operation information indicating a predetermined operation performed by a user during display of each content file;
a storage controlling section that stores the operation information for each content file in the second storage section;
an order determining section that determines the order of the plurality of content files according to the operation information stored in the second storage section for each content file; and
a list display controlling section that displays an image of a list on the display section, the list including the plurality of content files arrayed according to the order determined by the order determining section.

2. The display apparatus according to claim 1, wherein the storage controlling section stores the operation information in the second storage section according to time category of a day, and
wherein the order determining section determines the order according to the operation information corresponding to a current time category.

3. The display apparatus according to claim 1, wherein the storage controlling section stores, in the second storage section, cumulative number of times of the predetermined operation made by the user for each content file during display of each content file, and
wherein the order determining section determines the order according to the cumulative number of times.

4. The display apparatus according to claim 3, wherein the order determining section determines the order in descending order in terms of the cumulative number of times.

5. The display apparatus according to claim 3, wherein the order determining section determines the order in descending order in terms of a value obtained by a calculation using the cumulative number of times and information amount of each content file.

6. The display apparatus according to claim 5, wherein the order determining section determines the order in descending order in terms of a value obtained by dividing the cumulative number of times by the information amount of each content.

7. The display apparatus according to claim 1, wherein the list display controlling section displays, on the display section, an image of a list in which the content files are arrayed based on the order, sequentially from the top.

8. The display apparatus according to claim 1, wherein the order determining section determines the order with respect only to the content files that have been displayed at least once, and
wherein the list display controlling section arrays the content files that have been displayed at least once and content files that have never been displayed in areas different from each other, and displays an image of a list in which only the content files that have been displayed at least once are arrayed according to the order on the display section.

9. The display apparatus according to claim 1, further comprising:
a relevant information acquiring section that acquires relevant information indicating relevance between respective content files; and
a sorting section that sorts the order determined by the order determining section such that the content files having a high relevance are arrayed close to each other,
wherein the list display controlling section displays, on the display section, an image of a list in which the content files are arrayed based on the order sorted by the sorting section.

10. The display apparatus according to claim 1, wherein the content file includes a plurality of page data, the page data being one page worth of data including at least one of text and image data;
wherein the display controlling section displays, on the display section, images based on the image data of a different page in accordance with a page-turning operation performed by a user;
wherein the storage controlling section stores, in the second storage section, the operation information indicating the page-turning operation performed for each content file; and
wherein the order determining section determines the order according to the operation information indicating the page-turning operation stored in the second storage section.

11. The display apparatus according to claim 10, wherein the order determining section determines the order in descending order in terms of a value obtained by a calculation using, as the operation information, the cumulative number of times of the page-turning operation and the number of pages of each content file.

12. The display apparatus according to claim 1, wherein the list display controlling section displays, on the display section, an image of a list in which only a predetermined number of content files out of all the content files are arrayed, the order of the content files being determined by the order determining section.

13. A storage medium storing a display program that has a set of program instructions executable on a computer serving as a display apparatus, the display apparatus including:
a display section that displays a content including at least one of texts and images;
a first storage section that stores a plurality of content files;
a display controlling section that displays, on the display section, the content based on the plurality of content files; and
a second storage section that stores, for each content file, operation information indicating a predetermined operation performed by a user during display of each content file,
the set of program instructions comprising:
storing the operation information for each content file in the second storage section;
determining the order of the plurality of content files according to the operation information stored in the second storage section; and
displaying an image of a list on the display section, the list including the plurality of content files arrayed according to the determined order.
